(19) United States
(12) Patent Application Publication
(10) Pub. No.: US 2022/0268606 A1
(43) Pub. Date: Aug. 25, 2022

(54) PORTABLE WALK THROUGH SENSOR FRAME ASSEMBLY

(71) Applicants: Joseph Monteleone, Amherstburg (CA); Stephane Boucher, Tilbury (CA); Donald Butler, Tecumseh (CA); Kevin Butler, Tecumseh (CA)

(72) Inventors: Joseph Monteleone, Amherstburg (CA); Stephane Boucher, Tilbury (CA); Donald Butler, Tecumseh (CA); Kevin Butler, Tecumseh (CA)

(21) Appl. No.: 17/679,584

(22) Filed: Feb. 24, 2022

Related U.S. Application Data
(60) Provisional application No. 63/153,069, filed on Feb. 24, 2021.

(51) Int. Cl. G01D 11/30; F16M 13/02

(52) U.S. Cl. CPC G01D 11/30; F16M 13/02

(57) ABSTRACT

A sensor frame assembly that includes a plurality of extrusion members removeably attached to each other defining a walk through frame assembly. The extrusion members have an outer profile and a hollow interior space. The extrusion members include a top portion coupled to separated side portions. Each of the plurality of extrusion members includes a length that is less than four feet when disassembled. Each of the plurality of extrusion members includes a rectangular sectional outer profile wherein one corner of the rectangular profile is truncated at an angle forming a mounting surface. The mounting surface is angled relative to an orthogonal side of the outer profile.

### CROSS-REFERENCE TO RELATED APPLICATIONS

The instant application claims priority to U.S. Provisional Application Ser. No. 63/153,069 filed Feb. 24, 2021 the entire contents of which are incorporated herein by reference.

### FIELD OF THE INVENTION

The invention relates to portable sensor frame assemblies.

### BACKGROUND OF THE INVENTION

Generally, walkthrough type sensors have a large footprint and support structure that makes it a permanent fixture that is difficult to move to various locations. There is a need in the art for a portable sensor type frame that is easily assembled and disassembled and be moved to various locations. There is a need in the art for a portable sensor frame that may be easily shipped by a parcel service and fits on a standard pallet and weighs less than 50 pounds. There is a further need for a sensor frame assembly that allows forward sensing capabilities.

### SUMMARY OF THE INVENTION

In one aspect, there is disclosed a sensor frame assembly that includes a plurality of extrusion members removeably attached to each other defining a walk through frame assembly. The extrusion members have an outer profile and a hollow interior space. Each of the plurality of extrusion members includes a length that is less than four feet when disassembled.

In another aspect, there is disclosed a sensor frame assembly that includes a plurality of extrusion members removeably attached to each other defining a walk through frame assembly. The extrusion members have an outer profile and a hollow interior space. The extrusion members include a top portion coupled to separated side portions. Each of the plurality of extrusion members includes a length that is less than four feet when disassembled.

In a further aspect, there is disclosed a sensor frame assembly there is disclosed a sensor frame assembly that includes a plurality of extrusion members removeably attached to each other defining a walk through frame assembly. The extrusion members have an outer profile and a hollow interior space. The extrusion members include a top portion coupled to separated side portions. Each of the plurality of extrusion members includes a rectangular sectional outer profile wherein one corner of the rectangular profile is truncated at an angle forming a mounting surface.

### BRIEF DESCRIPTION OF THE DRAWINGS

FIG. 1 is a perspective view of a sensor frame assembly;

FIG. 2 is a perspective view of a top bracket;

FIG. 3 is a perspective view of a side bracket;

FIG. 4 is a perspective view of a T-bar;

FIG. 5 is a perspective view of a foot cover;

FIG. 6 is a perspective of a foot mounting plate;

FIG. 7 is a sectional view showing the upper side extrusion profile;

FIG. 8 is a sectional view showing the top extrusion profile;

FIG. 9 is a partial perspective view of a side and top extrusion member and a cover;

FIG. 10 is a perspective view of a top extrusion member showing the attachment holes;

FIG. 11 is a partial view of a side extrusion member showing the attachment holes;

FIG. 12 is a perspective view of a sensor mount;

FIG. 13 is a partial perspective view of an extrusion member and sensor bar;

FIG. 14 is a sectional view of an extrusion member and sensor bar;

FIG. 15 is a partial perspective view of a sensor bar.

### DETAILED DESCRIPTION OF THE PREFERRED EMBODIMENTS

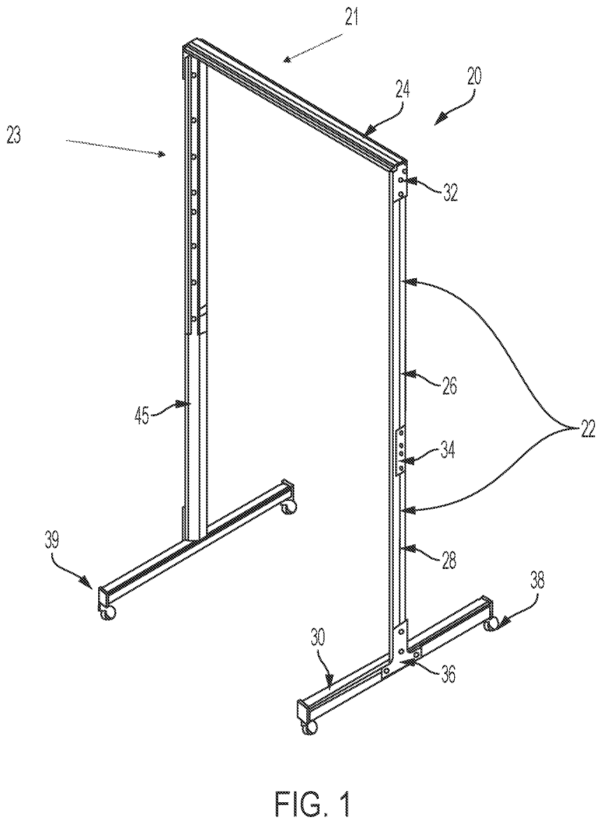

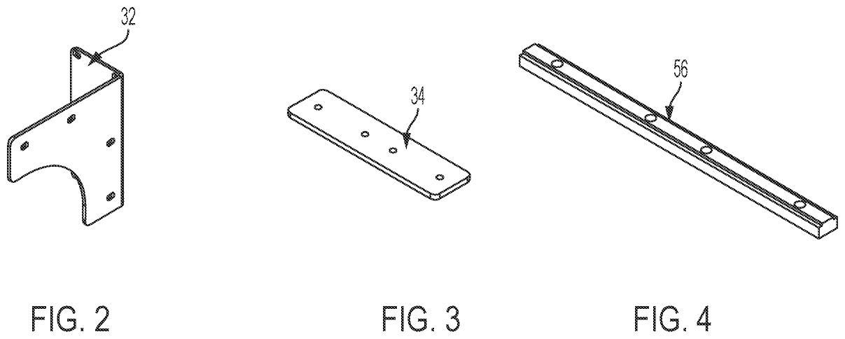

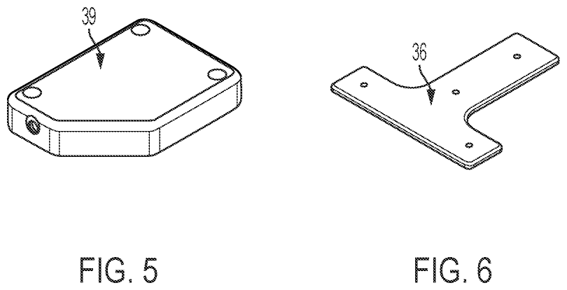

Referring to the FIGS. 1-6, there is shown a sensor frame assembly 20 that includes a plurality of extrusion members 22 removeably attached to each other to define a frame assembly 20. The sensor frame assembly 20 includes a top portion 21 that couples to separated side portions 23 to define a walk through frame assembly.

The plurality of extrusion pieces 22 include a top extrusion member 24 joined to upper side extrusion members 26. The upper side extrusion members 26 are connected to lower side extrusion members 28. The lower side extrusion members 28 are coupled to feet extrusion members 30. The extrusion members 22 may be coupled to each other using connection hardware 30 in conjunction with bores formed in the extrusion members 22 and fasteners. The connection hardware 30 includes a top mounting bracket 32 that connects the top extrusion member 24 to the upper side extrusion members 26. A side bracket 34 connects the upper side extrusion members 26 to the lower side extrusion members 28. A foot mounting plate 36 couples the lower side extrusion members 28 to the feet extrusion members 30. Casters 38 may be coupled to the feet extrusion members 30. A foot cap 39 may be utilized to seal the feet extrusions 30.

In one aspect, the extrusion members 22 may include various lengths. In one aspect the lengths of the individual extrusion members 22 does not exceed four feet, so that the assembly may be easily transported and fit in a box on a standard size pallet used for shipping. In this manner the sensor frame assembly 20 may be used in various locations and be easily shipped from one location to another using a standard shipping pallet. For example, the top extrusion member 24 may be 1066 mm, the upper side extrusion 26 may be 1219 mm, the lower side extrusion 28 and foot extrusion 30 may be 914 mm. The frame is dimensioned when assembled to allow a person to walk through the sensor frame assembly 20. The extrusion members 22 may be formed of aluminum to provide high strength and lightweight components.

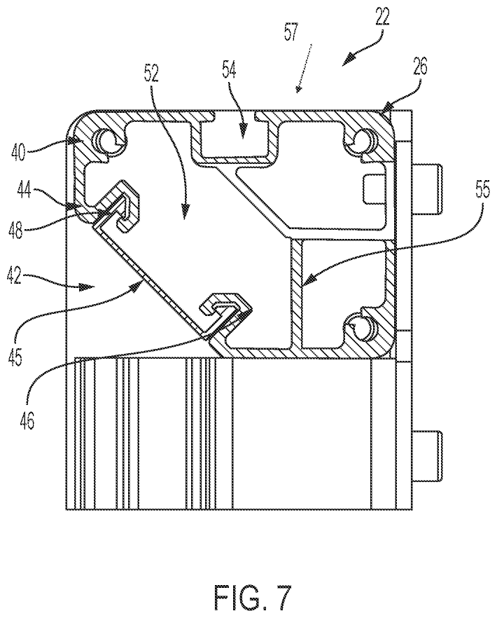

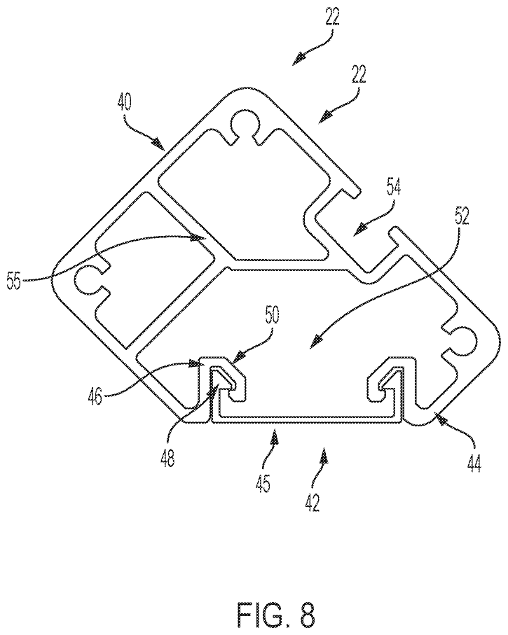

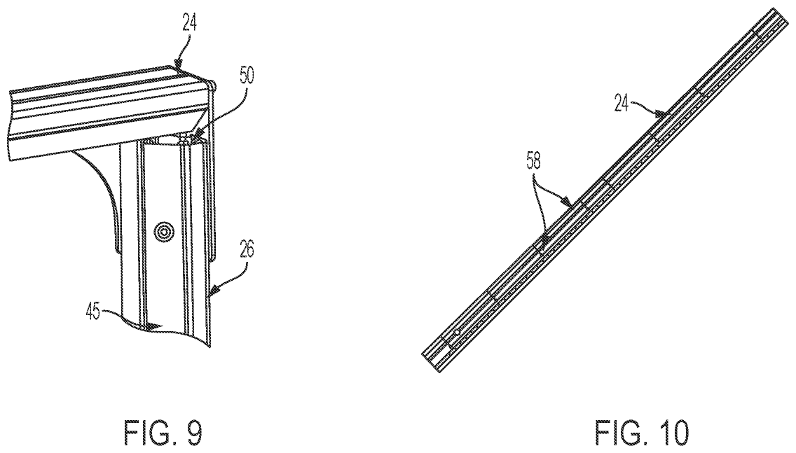

Referring to FIGS. 7-8, there is shown the sectional profile of the extrusion members 22. The sectional profile includes a generally outer rectangular profile 40. One corner 42 of the rectangular sectional profile 40 is truncated at an angle to form a mounting surface 44 for attaching a cover 45. The mounting surface 44 includes spring feet 46 formed thereon that connect with tabs 48 formed on the cover 45 or receive a portion of a sensor bar 60, as will be discussed in more detail below.

In one aspect, as shown in FIG. 8, the top extrusion member 24 may include a machined clearance 50 formed thereon on the spring feet 46 to assist in wire routing and assembly. The machined clearance 50 may be formed on the spring feet 46 on an interior facing portion of the spring feet 46. In other words toward a hollow interior space 52 of the top extrusion member 24. While the above structure is described with reference to the top extrusion member 24, it should be realized that the same description may also be for an upper side or lower side extrusion member 26, 28, as will be described in more detail below.

The extrusion members 22 include a hollow interior space 52 having a web structure 55. The web structure 55 includes a plurality of walls 57 that intersect each other and provide a strength and rigidity to the extrusion members 22. The walls 57 further define the interior space 52 into various portions.

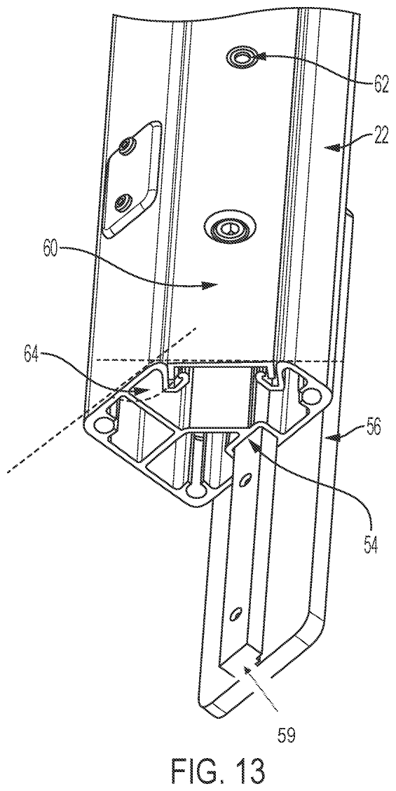

Wires and additional electronics may be routed in the hollow interior space 52. The extrusion members 22 may include a recess 54 formed on one side. The recess 54 may receive a T-bar structure 56 to connect the extrusion members 22. The T-bar structure 56 includes a raised profile 59 disposed in the recess 54, as best seen in FIG. 13. In one aspect, the raised profile 59 is disposed in recesses 54 of adjacent extrusions 22 to connect the adjacent extrusions 22 to each other.

In the depicted FIG. 13, it can be seen that a portion of the raised profile 59 is disposed in the extrusion 22 and another portion is extending out. This portion extending out would be disposed in an adjacent recess 54 of an extrusion member 22.

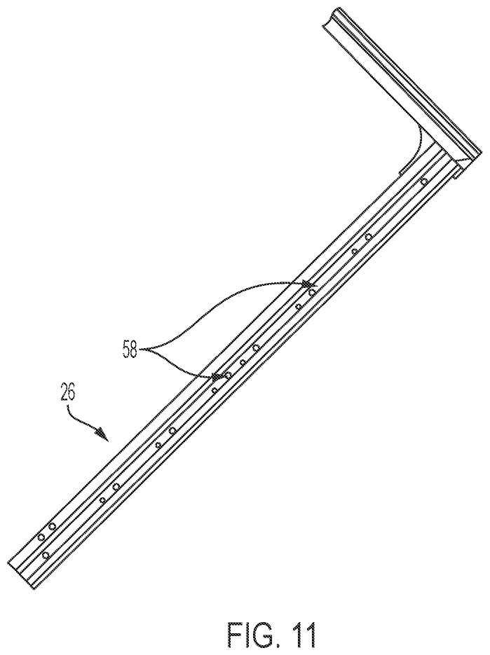

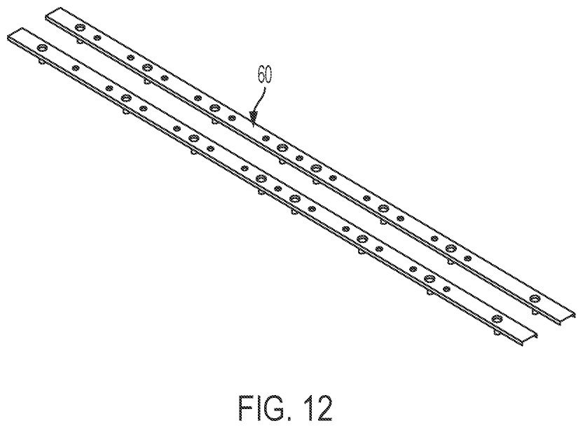

Referring to FIG. 10, the top extrusion member 24 may include holes 58 formed therein in a specified pattern to allow attachment of a sensor bar 60 structure best seen in FIGS. 12-15. Sensors 62 may be attached to the sensor bar 60, which in turn is attached to the extrusion member 22. Various sensors such as metal detector, thermal sensors or facial recognition cameras as well as others may be utilized.

Referring to FIG. 11, the upper side extrusion members 26 may also include holes 58 formed therein in a specified pattern to allow attachment of a sensor bar 60 structure best seen in FIGS. 12-15. Sensors 62 may be attached to the sensor bar 60, which in turn is attached to the extrusion member 22. Various sensors such as metal detector, thermal sensors or facial recognition cameras as well as others may be utilized. In one aspect, the sensor bar 60 includes feet 61 extending therefrom and are disposed in the spring feet 46. Fasteners 53 may be utilized to connect the sensor bar to the extrusion member 22, as will be described in more detail below.

As can be seen from the above description, sensors 62 may be disposed on at least one of the top extrusion member 24, or side extrusions 26, 28 or both. This structure allows for various arrangements of sensors 62 as the application requires.

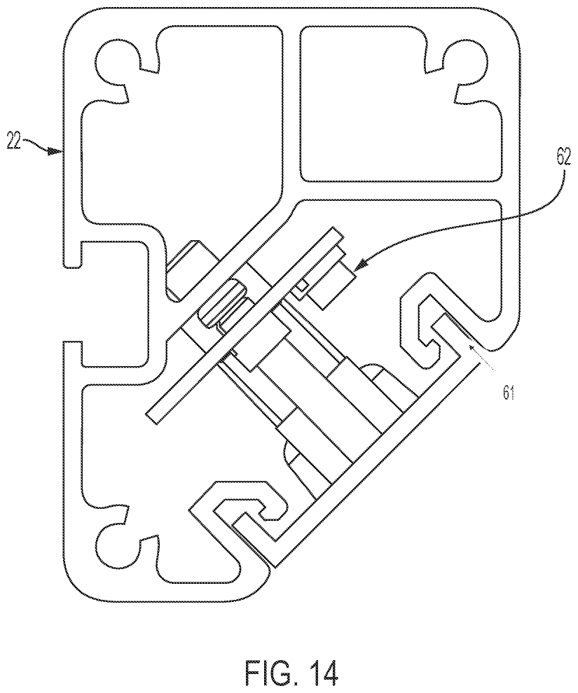

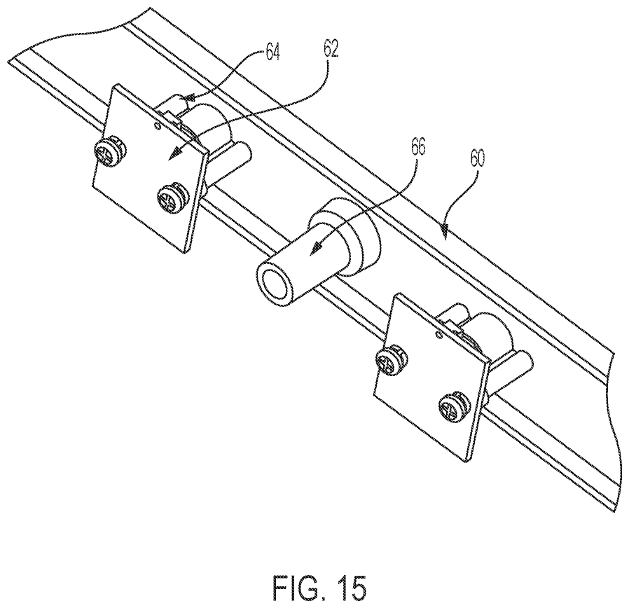

As shown in FIGS. 13-14, the truncated corner 42 allows for the sensor bar 60 to be mounted at an angle 64, as best seen in FIG. 13. The angle is relative to the orthogonal sides of the outer profile 40 of the extrusion members 22. The angle 64 allows the sensors 62 to project in front of the frame assembly 20. The front may be defined as the portion of the sensor frame assembly 20 facing a person who will pass through the sensor frame assembly. In this manner the sensors 62 may provide readings before a person passes through the frame assembly 20. In one aspect, the angle 64 may be on all of the plurality of extrusion members 22, described above.

The sensors 62 may be attached to the sensor bar 60 at bosses 66 formed on the sensor bar 60 using fasteners 65 as best seen in FIG. 15. Attachment bosses 68 may be used to attach the sensor bar 60 to the extrusion members 22 using fasteners 53.

In use, extrusion members 22 may be attached to each other as described above. The sensor bar 60 may attached to at least one of the extrusion members 22 as described above. The covers 45 may be attached to the extrusion members 22 not including the sensor bar 60 to form a sealed freestanding walk through frame assembly.

The frame assembly 20 may be utilized as an access point for various uses. The frame assembly 20 may be used to check the temperature of an individual or as a point of entry system for an airport, stadium or other venue. The frame assembly 20 may be easily assembled and disassembled and can have a variety of sensors. The frame assembly 20 may be easily shipped to various locations due to the specified size and weight of the extrusion members 22.

1. A sensor frame assembly comprising:
a plurality of extrusion members removeably attached to each other defining a walk through frame assembly;
the extrusion members having an outer profile and a hollow interior space;
wherein each of the plurality of extrusion members includes a length that is less than four feet when disassembled.

2. The sensor frame assembly of claim 1 wherein each of the plurality of extrusion members includes a rectangular sectional outer profile wherein one corner of the rectangular profile is truncated at an angle forming a mounting surface.

3. The sensor frame assembly of claim 2 wherein the mounting surface includes spring feet formed thereon that connect with tabs formed on a cover removeably attaching the cover to the extrusion member.

4. The sensor frame assembly of claim 3 wherein the spring feet include a machined clearance formed thereon, the machined clearance formed on a portion of the spring feet facing the hollow interior space of the extrusion member.

5. The sensor frame assembly of claim 1 wherein the extrusion members include a web structure formed thereon in the hollow interior space, the web structure including a plurality of walls that intersect.

6. The sensor frame assembly of claim 1 wherein the extrusion members include a recess formed on a side of the outer profile, the recess receiving a T-bar structure that is attached to adjacent extrusions connecting the adjacent extrusions.

7. The sensor frame assembly of claim 1 including at least one sensor bar attached to at least one of the plurality of extrusion members.

8. The sensor frame assembly of claim 2 including at least one sensor bar attached to at least one of the plurality of extrusion members at the mounting surface and wherein the at least one sensor bar is angled relative to an orthogonal side of the outer profile.

9. The sensor frame assembly of claim 7 wherein the sensor bar includes attachment bosses formed thereon, the attachment bosses receiving fasteners attaching the sensor bar to the at least one extension member.

10. The sensor frame assembly of claim 9 wherein the sensor bar includes bosses formed thereon, the bosses receiving fasteners attaching the sensors to the at least one sensor bar.

11. A sensor frame assembly comprising:
a plurality of extrusion members removeably attached to each other defining a walk through frame assembly;
the extrusion members having an outer profile and a hollow interior space;
the plurality of extrusion members including a top portion coupled to separated side portions;
wherein each of the plurality of extrusion members includes a length that is less than four feet when disassembled.

12. The sensor frame assembly of claim 11 wherein each of the plurality of extrusion members includes a rectangular sectional outer profile wherein one corner of the rectangular profile is truncated at an angle forming a mounting surface.

13. The sensor frame assembly of claim 12 wherein the mounting surface includes spring feet formed thereon that connect with tabs formed on a cover removeably attaching the cover to the extrusion member.

14. The sensor frame assembly of claim 13 wherein the spring feet include a machined clearance formed thereon, the machined clearance formed on a portion of the spring feet facing the hollow interior space of the extrusion member.

15. The sensor frame assembly of claim 11 wherein the extrusion members include a web structure formed thereon in the hollow interior space, the web structure including a plurality of walls that intersect.

16. The sensor frame assembly of claim 11 wherein the extrusion members include a recess formed on a side of the outer profile, the recess receiving a T-bar structure that is attached to adjacent extrusions connecting the adjacent extrusions.

17. The sensor frame assembly of claim 1 including at least one sensor bar attached to at least one of the plurality of extrusion members.

18. The sensor frame assembly of claim 2 including at least one sensor bar attached to at least one of the plurality of extrusion members at the mounting surface and wherein the at least one sensor bar is angled relative to an orthogonal side of the outer profile.

19. The sensor frame assembly of claim 7 wherein the sensor bar includes attachment bosses formed thereon, the attachment bosses receiving fasteners attaching the sensor bar to the at least one extension member and wherein the sensor bar includes bosses formed thereon, the bosses receiving fasteners attaching the sensors to the at least one sensor bar.

20. A sensor frame assembly comprising:
a plurality of extrusion members removeably attached to each other defining a walk through frame assembly;
the extrusion members having an outer profile and a hollow interior space;
the plurality of extrusion members including a top portion coupled to separated side portions;
wherein each of the plurality of extrusion members includes a rectangular sectional outer profile wherein one corner of the rectangular profile is truncated at an angle forming a mounting surface.
